(19) United States
(12) Patent Application Publication
(10) Pub. No.: US 2004/0163689 A1
(43) Pub. Date: Aug. 26, 2004

(54) Dishwasher

(76) Inventor: Yong Jae Lee, Ulsan-si (KR)

Correspondence Address: FLESHNER & KIM, LLP, P.O. BOX 221200, CHANTILLY, VA, 20153, US

(21) Appl. No.: 10/721,740

(22) Filed: Nov. 26, 2003

(30) Foreign Application Priority Data
Nov. 28, 2002 (KR) P2002-74992

(51) Int. Cl. B08B 3/02

(52) U.S. Cl. 134/94.1; 134/186; 134/103.1; 134/198; 134/200

(57) ABSTRACT

A dishwasher minimizes the backflow of water to a sump and the gathering of water in a drain passage, by constructing the drain passage using a valve installed at the vertical peak of a passage for preventing the backflow of water. The dishwasher includes a sump, installed under a washtub, for collecting water; a drain pump, installed at one side of the sump, for pumping to a pressure and thereby draining the water collected in the sump; a drain passage having one end communicating with the drain pump; a backflow-preventing passage installed so as to have a peak point of an inverted U-shape piece, whose entrance end is connected to the other end of the drain passage to prevent the water from flowing backward, disposed higher than the sump; a drain hose having one end connected to the other end of the backflow-preventing passage; and a check valve, installed at the entrance end of the backflow-preventing passage, for opening and closing the entrance end of the backflow-preventing passage according to an operational status of the drain pump.

This application claims the benefit of Korean Application No. 10-2002-0074992 filed on Nov. 28, 2002, which is hereby incorporated by reference.

### BACKGROUND OF THE INVENTION

1. Field of the Invention

The present invention relates to a dishwasher, and more particularly, to a dishwasher having a drain apparatus minimizing the amount of water flowing backward to a sump and reduces an amount of water collecting in a drain passage.

2. Discussion of the Related Art

Generally speaking, a dishwasher is provided with a drain apparatus for draining used water from the dishwasher. A pressure differential (water head) created by a draining operation causes the drained water to flow backwards in a drain passage toward a sump. To prevent such a phenomenon, the dishwasher is typically provided with a check valve and a backflow-preventing passage having a peaked structure rising well above the height of the sump.

Referring to FIG. 1, a dishwasher according to a related art comprises a body 2 having a door 2a; a washtub 4, installed in the body, where the washing is performed; a sump 6, installed under the washtub, for collecting water; a water supply valve 8 and a water supply passage 9, installed at one side of the body, for supplying water to the washtub; a nozzle 10, rotatably installed at the end of an injection passage 10a communicating with the sump, for spraying water into the washtub; a wash pump 12, installed at one side of the sump, for pumping water toward the injection passage and nozzle; and a drain apparatus 20, installed at the other side of the sump, for draining water.

The drain apparatus 20 comprises a drain pump 21, communicating with the sump 6, for pumping the water being drained from the sump; a first drain passage 22 disposed vertically from one end of the drain pump; a backflow-preventing passage 23, which is essentially an inverted U-shaped piece having a peak point P rising above the sump to prevent water backflow; a second drain passage 24 disposed vertically at the exiting end of the backflow-preventing passage; a drain hose 25, connected to the second drain passage, for guiding discharged water to an external drain (not shown); and a hinged check valve 26, installed between the second drain passage and the drain hose, which is opened only by the pressure of draining water and is otherwise closed to prevent the discharged water of the drain hose from re-entering the dishwasher when the drain pump stops. The backflow-preventing passage 23 is connected between the vertically disposed first and second drain passages 22 and 24 and comprises first and second backflow-preventing passages 23a and 23b respectively connected to the first and second drain passages. To prevent the water from flowing backward through the draining apparatus 20 due to a pressure differential created by a draining operation, the peak point P of the backflow-preventing passage 23 should be at least as high as a normal water supply level in the washtub 4 and higher than the sump 6. Thus, the peak point P is set at a predetermined height “h.”

There are two fundamental operating conditions of the above-described dishwasher, and in particular, the drain pump 21, which affects the operation of the drain apparatus 20. That is, the drain pump 21 is either driven during a draining operation as shown in FIG. 2 or is stopped as shown in FIG. 3.

As shown in FIG. 2, when the drain pump 21 is driven and the check valve 26 is opened by the pressure of the draining water, the water in the washtub 4 and sump 6 is pumped by the drain pump, to be discharged via the first drain passage 22, backflow-preventing passage 23, second drain passage 24, and drain hose 25. As the drain pump 21 operates, the water passing through the backflow-preventing passage 23 is drained despite the presence of a high water head.

As shown in FIG. 3, when the drain pump 21 is stopped and the check valve 26 is closed due to the absence of the pressure of draining water, the water present in the drain apparatus 20 begins to flow from a higher level to a lower level. In particular, the water in the first drain passage 22 and first backflow-preventing passage 23a flows backward to the sump 6. Meanwhile, the water in the second backflow-preventing passage 23b, the second drain passage 24, and even a portion in the drain hose 25 collects along the drain apparatus 20 at points upstream of the check valve 26, which is closed as the water of the drain hose 25 flows backward. The backflow water contaminates the sump 6 and washtub 4, and the collected water stagnates. Such water is unsanitary and generates a foul odor.

### SUMMARY OF THE INVENTION

Accordingly, the present invention is directed to a dishwasher that substantially obviates one or more of the problems due to limitations and disadvantages of the related art.

An object of the present invention, which has been devised to solve the foregoing problem, lies in providing a dishwasher, which minimizes an amount of water flowing backward to a sump and reduces an amount of water collecting in a drain passage, by installing a check valve at the entranced of a backflow-preventing passage.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a dishwasher comprising a sump, installed under a washtub, for collecting water; a drain pump, installed at one side of the sump, for pumping to a pressure and thereby draining the water collected in the sump; a drain passage having one end communicating with the drain pump; a backflow-preventing passage installed so as to have a peak point of an inverted U-shape piece, whose entrance end is connected to the other end of the drain passage to prevent the water from flowing backward, disposed higher than the sump; a drain hose having one end connected to the other end of the backflow-preventing passage; and a check valve, installed at the entrance end of the backflow-preventing passage, for opening and closing the entrance end of the backflow-preventing passage according to an operational status of the drain pump.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a dishwasher according to a related art;

FIG. 2 is a cross-sectional view of the drain apparatus of FIG. 1, illustrating an operational status during the driving of a wash pump;

FIG. 3 is a cross-sectional view of the drain apparatus of FIG. 1, illustrating an operational status when a wash pump is stopped;

FIG. 4 is a cross-sectional view of a dishwasher according to the present invention;

FIG. 5 is a cross-sectional view of the drain apparatus of FIG. 4, illustrating an operational status during the driving of a wash pump;

FIG. 6 is a cross-sectional view of the drain apparatus of FIG. 4, illustrating an operational status when a wash pump is stopped; and

FIG. 7 is a cross-sectional view of a dishwasher according to a preferred embodiment of the present invention.

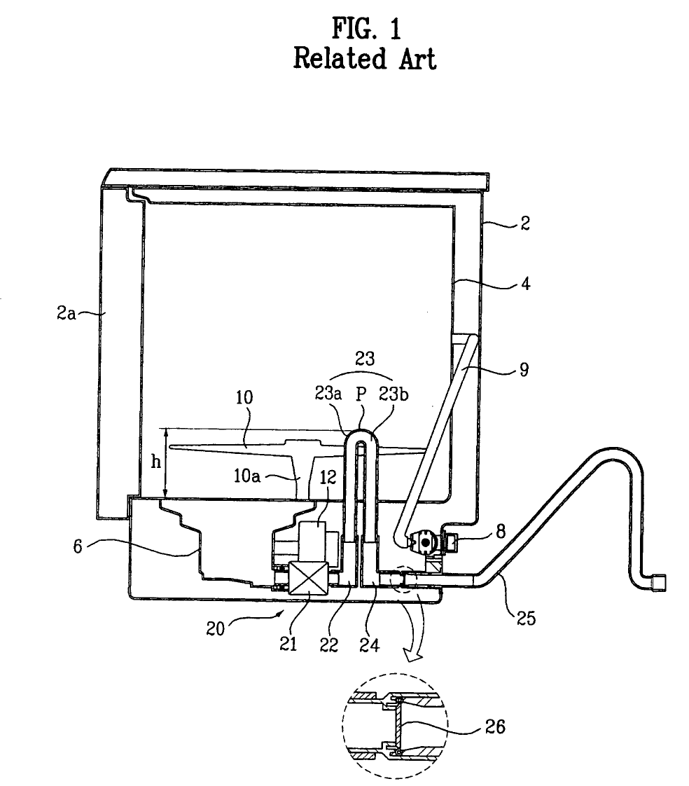

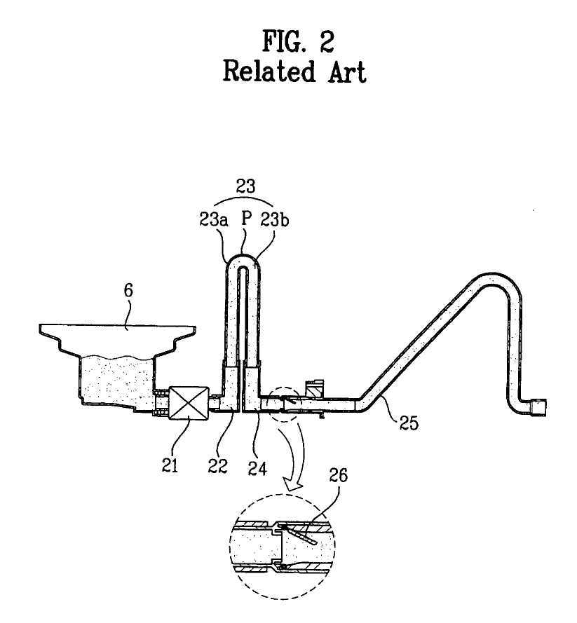

### DETAILED DESCRIPTION OF THE PREFERRED EMBODIMENTS

Reference will now be made in detail to the preferred embodiments of the present invention, examples of which are illustrated in the accompanying drawings.

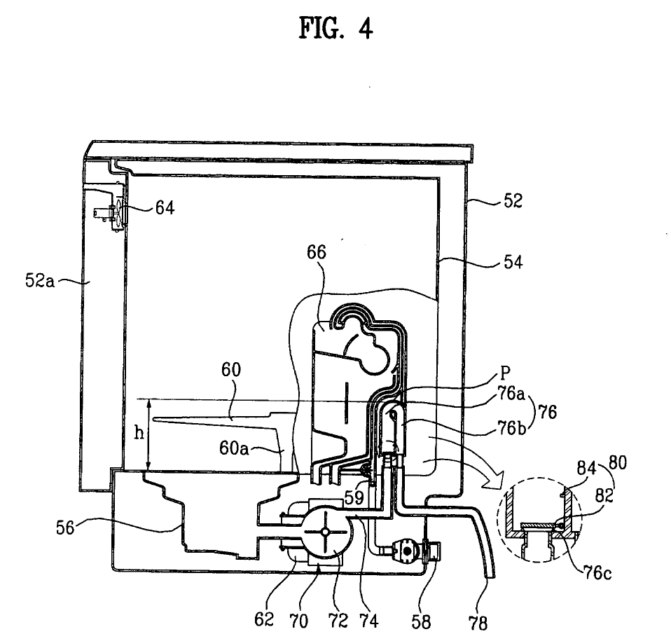

Referring to FIG. 4, a dishwasher according to the present invention comprises a body 52 having a door 52a; a washtub 54, installed in the body, where the washing is performed; a sump 56, installed under the washtub, for collecting water; a water supply valve 58 and a water supply passage 59, installed at one side of the body, for supplying water to the washtub; a nozzle 60, rotatably installed at the end of an injection passage 60a communicating with the sump, for spraying water into the washtub; a wash pump 62, installed at one side of the sump, for pumping water toward the injection passage and nozzle; and a drain apparatus 70, installed at the other side of the sump, for draining water. A blowing fan 64 is installed in the door 52a to discharge heated air, and a drying air intake passage 66 is installed in one side of the body 52 to draw in external air for drying.

The drain apparatus 70 is primarily installed in a space provided between the bottom of the wash tub 54 and bottom of the body 52, with the drain pump 72, drain passage 74, and drain hose 78 being installed to the side of the sump 56. The backflow-preventing passage 76 is installed in a space between one side of the washing tub 54 and the body 52. To reduce installation space, the dry air intake passage 66, the backflow-preventing passage 76, and the water supply passage 59 are partitioned by one integrally formed member.

The drain apparatus 70 comprises a drain pump 72, communicating with the sump 56, for pumping the water being drained from the sump; a drain passage 74 installed vertically to have a bottom end connected to the drain pump; a backflow-preventing passage 76, which is essentially an inverted U-shaped piece whose peak point P is higher than the sump to prevent water from flowing backward, having one end connected to the drain passage 74 and the other end connected to a drain hose 78 for guiding discharged water to an external drain (not shown), and a check valve 80 disposed between the drain passage and the backflow-preventing passage, i.e., upstream of the peak point P. The backflow-preventing passage 76 is connected between the drain passage 74 and drain hose 78 and comprises first and second backflow-preventing passages 76a and 76b respectively connected to the drain passage and drain hose. To prevent the water from flowing backward through the draining apparatus 70 due to a pressure differential created by a draining operation, the peak point P of the backflow-preventing passage 76 should be at least as high as a normal water supply level in the washtub 54 and higher than the sump 56. Thus, the peak point P is set at a predetermined height “h.”

The check valve 80 is installed to open and close the entrance of the backflow-preventing passage 76, which is opened by water pressure resulting from the operation of the drain pump 72 and is closed when the drain pump stops operating. The check valve 80 comprises a sealing member 82, hinged with respect to an inner surface of the backflow-preventing passage 76 and preferably formed of rubber, for closing the entrance of the backflow-preventing passage 76; and a support member 84, having a predetermined elasticity and preferably formed of rubber, installed on a predetermined point of the inner surface of the backflow-preventing passage 76 to receive and elastically support the distal end of the sealing member when the check valve is opened. An annular rib 76c is provided at the entrance of the backflow-preventing passage 76, protruding inward from the perimeter thereof, to receive the sealing member 82 upon closing and thereby assist in its sealing action. The sealing member 82 is installed so as to use its own weight to block the entrance of the backflow-preventing passage 76 when the drain pump 72 stops operating.

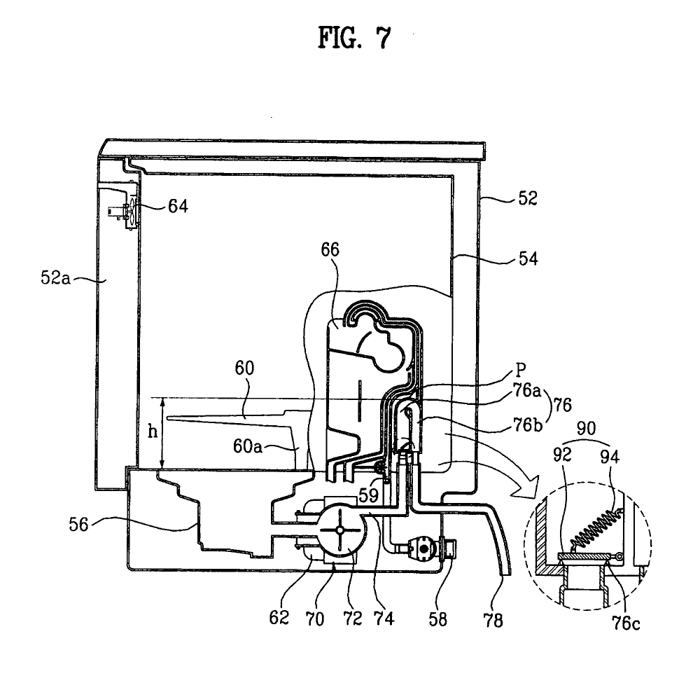

Meanwhile, a preferred embodiment of the check valve of the drain apparatus of the dishwasher of the present invention is shown in FIG. 7. Here, a check valve 90 comprises a sealing member 92, hinged with respect to an inner wall of the backflow-preventing passage 76 and preferably formed of rubber, for closing the entrance of the backflow-preventing passage 76; and a buffer member 94, formed as a spring or the like physically linking the sealing member to an inner surface of the backflow-preventing passage, for pushing the sealing member upon closing the entrance of the backflow-preventing passage. Upon stopping the drain pump 72, if the pressure of the water flowing in the backflow-preventing passage 76 drops below a predetermined value, the buffer member 94 assists the sealing member 92 in blocking the entrance of the backflow-preventing passage 76.

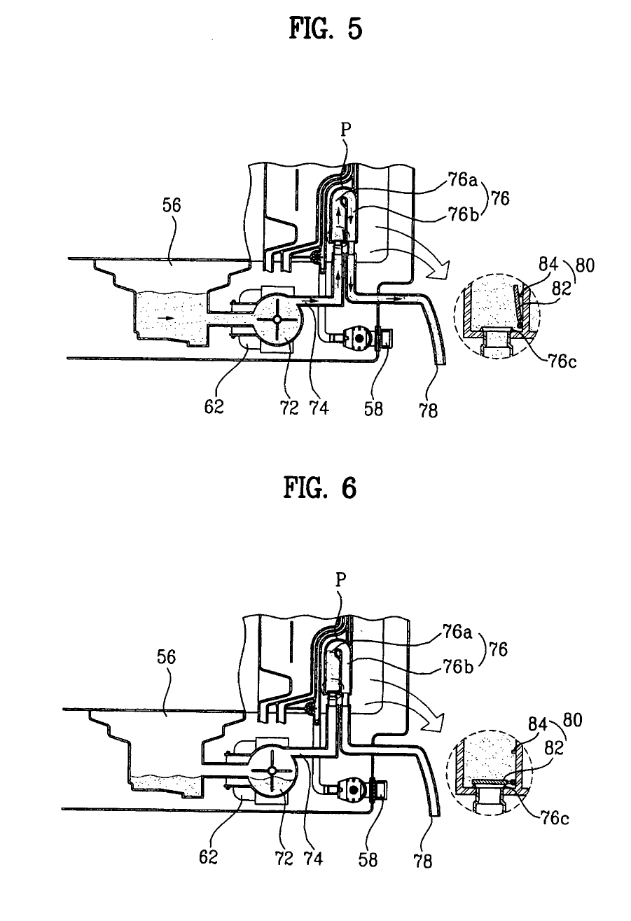

There are two fundamental operating conditions of the above-described dishwasher, and in particular, the drain pump 72, which affects the operation of the drain apparatus 70. That is, the drain pump 72 is either driven during a draining operation as shown in FIG. 5 or is stopped as shown in FIG. 6.

As shown in FIG. 5, when the drain pump 72 is driven and the check valve 80 (90) is opened by the pressure of the draining water, the water in the washtub 54 and sump 56 is pumped by the drain pump, to be discharged via the drain passage 74, backflow-preventing passage 76, and drain hose 78. As the drain pump 72 operates, the water passing through the backflow-preventing passage 76 is drained despite the presence of a high water head. In doing so, the hinged sealing member 82 of the check valve 80 pivots on its hinge to open the entrance of the backflow-preventing passage 76 under the pressure of the draining water, while its distal end is supported by the support member 84.

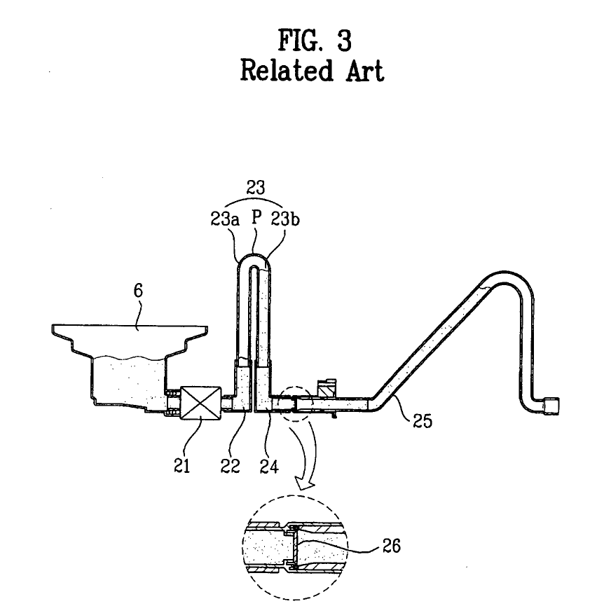

As shown in FIG. 3, when the drain pump 72 is stopped and the check valve 80 is closed due to the absence of the pressure of draining water, the water present in the drain apparatus 70 begins to flow from a higher level to a lower level. In particular, while the water draining along the second backflow-preventing passage 76b and the drain hose 78 continues draining, the water in the drain passage 74 flows backward to the sump 56, but since the check valve 80 is positioned at the entrance of the backflow-preventing passage 76, the water in the first backflow-preventing passage 76a is blocked as the pressure of the draining water drops, so that the water collects only between the peak point P of the backflow-preventing passage 76 and check valve 80. Thus, even if a portion of the water present in the drain passage 74 flows backward to the sump 56, the amount of water flowing backward to the sump 56 is minimized since the drain passage 74 is relatively short.

Accordingly, in the dishwasher according to the present invention, the check valve is provided at the entrance of the backflow-preventing passage to be controlled by the water pressure of the drain pump. Therefore, the present invention minimizes the amount of the water flowing backward to the sump when the drain pump stops operating and reduces the amount collected upstream of the check valve, to thereby avoid contamination of the sump and washtub, improve the sanitary conditions for storing tableware and the like in the dishwasher, and reduce the generation of odors.

Moreover, the drying air intake passage, backflow-preventing passage, and water supply passage are partitioned by one integrally formed member, for installation between the side of the washtub and the body, thus reducing the number of components required for assembly, to increase productivity and reduce product size.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A dishwasher comprising:
a sump, installed under a washtub, for collecting water;
a drain pump, installed at one side of the sump, for pumping to a pressure and thereby draining the water collected in the sump;
a drain passage having one end communicating with the drain pump;
a backflow-preventing passage installed so as to have a peak point of an inverted U-shape piece, whose entrance end is connected to the other end of the drain passage to prevent the water from flowing backward, disposed higher than the sump;
a drain hose having one end connected to the other end of the backflow-preventing passage; and
a check valve, installed at the entrance end of the backflow-preventing passage, for opening and closing the entrance end of the backflow-preventing passage according to an operational status of the drain pump.

2. The dishwasher as claimed in claim 1, wherein the check valve opens the entrance end of the backflow-preventing passage when the drain pump is actuated and closes the entrance end of the backflow-preventing passage when the drain pump is not actuated.

3. The dishwasher as claimed in claim 2, the check valve comprising:
a sealing member, hinged with respect to an inner surface of the backflow-preventing passage, for closing the entrance of the backflow-preventing passage; and
a support member having a predetermined elasticity, installed between the sealing member and a predetermined point of the inner side of the backflow-preventing passage, to receive and elastically support a distal end of the sealing member when the check valve is opened.

4. The dishwasher as claimed in claim 3, further comprising an annular rib for receiving the sealing member upon closing, the annular rib protruding inwardly from a perimeter surface of the entrance of the backflow-preventing passage.

5. The dishwasher as claimed in claim 3, wherein the sealing member is formed of a rubber-based material.

6. The dishwasher as claimed in claim 3, wherein the support member is a spring pushing the sealing member upon closing the entrance of the backflow-preventing passage, the spring linking the sealing member to the predetermined point of the inner surface of the backflow-preventing passage and being controlled according the pressure of the water flowing in the backflow-preventing passage.

7. The dishwasher as claimed in claim 6, wherein the spring pushes the sealing member to close the entrance of the backflow-preventing passage, if the pressure of the water flowing in the backflow-preventing passage drops below a predetermined value.

8. The dishwasher as claimed in claim 1, wherein the backflow-preventing passage is partitioned at one side of a dry air intake passage through which external air is drawn for drying.
